(19) United States
(12) Patent Application Publication
(10) Pub. No.: US 2018/0356903 A1
(43) Pub. Date: Dec. 13, 2018

(54) PROGRAM, COMPUTER APPARATUS, PROGRAM EXECUTION METHOD, AND, COMPUTER SYSTEM

(71) Applicant: SQUARE ENIX CO., LTD., Tokyo (JP)

(72) Inventor: Koji SUGIMOTO, Tokyo (JP)

(73) Assignee: SQUARE ENIX CO., LTD., Tokyo (JP)

(21) Appl. No.: 15/781,815

(22) PCT Filed: Nov. 30, 2016
(86) PCT No.: PCT/JP2016/085594

§ 371 Date: Jun. 6, 2018

(30) Foreign Application Priority Data
Dec. 9, 2015 (JP) 2015-240650

(51) Int. Cl. G06F 3/03; A63F 13/213; A63F 13/426; A63F 13/837; G06F 3/01

(52) U.S. Cl. CPC G06F 3/0321; A63F 13/213; G06F 3/016; A63F 13/837; A63F 13/426

(57) ABSTRACT

Provided is a program executed in a computer apparatus which is capable of communicating with or being connected to a photographing device that photographs different light beams irradiated to an irradiation target surface from a plurality of light beam irradiation devices, the program causing the computer apparatus to function as an identificator that identifies the light beam irradiation devices corresponding to the light beams photographed by the photographing device, and a calculator that performs calculation of a predetermined program by using a position on the irradiation target surface for the light beam irradiation device identified by the identificator, as input data.

### TECHNICAL FIELD

The present invention relates to a program, a computer apparatus, a program execution method, and, a computer system.

### BACKGROUND ART

In recent years, shooting games using a gun type controller have been known. Examples of the shooting game include a game in which the position of a light beam, which is projected onto a screen by using a gun type controller emitting a laser beam, is photographed using an optical device such as a video camera so that a user identifies a position aimed by shooting. In this shooting game, the position irradiated with the laser beam on the screen is photographed using the optical device, and the game proceeds while identifying the user's aimed position. However, in this method, the number of video cameras corresponding to the number of controllers is required, which results in a problem of an increase in costs. Consequently, as a realization method at low costs, there has been proposed a method (see, for example, Patent Literature 1) in which only one optical device is provided, and a plurality of gun type controllers are perceived by using a light beam having a shape pattern which is different for each gun type controller.

### CITATION LIST

### Patent Literature

Patent Literature 1 JP 2000-189671 A

### SUMMARY OF INVENTION

### Technical Problem

However, in the method disclosed in Patent Literature 1, there is a concern that a shape pattern of a light beam changes on a screen depending on an angle at which the screen is irradiated with the light beam and cannot be normally perceived. In addition, shape patterns of light beams do not have the same shape even when the shape patterns are ordinarily rotated at any angle of 360 degrees like a circle. Accordingly, in order to normally recognize a shape pattern of a light beam in any cases, processing related to pattern matching has to be added, and thus an excessive load may be applied to a computer apparatus. Further, in a case where a plurality of users play a game, there is also a problem in that the shape of a light beam cannot be temporarily recognized when a portion of the light beam is shielded by the user's hand or the like.

An object of at least one embodiment of the present invention is to provide a program, a computer apparatus, a program execution method, and a system which make a light beam irradiation device normally perceivable without depending on an irradiation angle of a light beam.

### Solution to Problem

According to a non-limiting aspect, a program executed in a computer apparatus which is capable of communicating with or being connected to a photographing device that photographs different light beams irradiated to an irradiation target surface from a plurality of light beam irradiation devices, the program causing the computer apparatus to function as: an identificator that identifies the light beam irradiation devices corresponding to the light beams photographed by the photographing device; and a calculator that performs calculation of a predetermined program by using a position on the irradiation target surface for the light beam irradiation device identified by the identificator, as input data.

According to a non-limiting aspect, a computer apparatus which is capable of communicating with or being connected to a photographing device that photographs different light beams irradiated to an irradiation target surface from a plurality of light beam irradiation devices, the computer apparatus including: an identificator that identifies the light beam irradiation devices corresponding to the light beams photographed by the photographing device; and a calculator that performs calculation of a predetermined program by using a position on the irradiation target surface for the light beam irradiation device identified by the identificator, as input data.

According to a non-limiting aspect, a program execution method executed in a computer apparatus which is capable of communicating with or being connected to a photographing device that photographs different light beams irradiated to an irradiation target surface from a plurality of light beam irradiation devices, the program execution method including: a step of identifying the light beam irradiation devices corresponding to the light beams photographed by the photographing device; and a step of performing calculation of a predetermined program by using a position on the irradiation target surface for the identified light beam irradiation device, as input data.

According to a non-limiting aspect, a computer system including: a plurality of light beam irradiation devices that irradiate an irradiation target surface with a light beam having a predetermined periodic pattern; a photographing device that photographs the light beam with which the irradiation target surface is irradiated; and a computer apparatus that is capable of communicating with or being connected to the photographing device, wherein the light beam irradiation device includes a light beam irradiator that irradiates an irradiation target surface with different light beams, wherein the photographing device includes a photographer that photographs the light beam with which the irradiation target surface is irradiated, and a transmitter that transmits photographing data obtained by the photographing of the photographer to the computer apparatus, and wherein the computer apparatus includes a receptor that receives the photographing data from the photographing device, an identificator that identifies the light beam irradiation device corresponding to the photographed light beam, on the basis of the received photographing data, and a calculator that performs calculation of a predetermined program by using a position on the irradiation target surface for the light beam irradiation device identified by the identificator, as input data.

### Advantageous Effect of Invention

One or more of the above problems can be solved with each embodiment of the present invention.

### BRIEF DESCRIPTION OF DRAWINGS

FIG. 1 is a block diagram illustrating a configuration of a computer apparatus, which corresponds to at least one embodiment according to the present invention.

FIG. 2 is a flowchart of a program executing process, which corresponds to at least one embodiment according to the present invention.

FIG. 3 is a block diagram illustrating a configuration of a light beam irradiation device, which corresponds to at least one embodiment according to the present invention.

FIG. 4 is a block diagram illustrating a configuration of a photographing device, which corresponds to at least one embodiment according to the present invention.

FIG. 5 is a block diagram illustrating a configuration of a computer apparatus, which corresponds to at least one embodiment according to the present invention.

FIG. 6 is a flowchart of a program executing process, which corresponds to at least one embodiment according to the present invention.

FIG. 7 is a block diagram illustrating a configuration of a system, which corresponds to at least one embodiment according to the present invention.

FIG. 8 is a block diagram illustrating a configuration of a computer apparatus, which corresponds to at least one embodiment according to the present invention.

FIG. 9 is an example of a game execution screen, which corresponds to at least one embodiment according to the present invention.

FIG. 10 is a flowchart of a program executing process, which corresponds to at least one embodiment according to the present invention.

FIGS. 11A and 11B are diagrams related to an example of a blinking pattern, which correspond to at least one embodiment according to the present invention.

FIG. 12 is a flowchart of a process of perceiving a light beam irradiation device, which corresponds to at least one embodiment according to the present invention.

FIG. 13 is a diagram illustrating a blinking pattern master table, which corresponds to at least one embodiment according to the present invention.

FIGS. 14A and 14B are diagrams illustrating a determination method related to a change in positional coordinates, which correspond to at least one embodiment according to the present invention.

FIG. 15 is a diagram illustrating an action determination data table, which corresponds to at least one embodiment according to the present invention.

### DESCRIPTION OF EMBODIMENTS

Hereinafter, embodiments of the present invention will be described with reference to the accompanying drawings. Hereinafter, description relating to effects shows an aspect of the effects of the embodiments of the present invention, and does not limit the effects. Further, the order of respective processes that form a flowchart described below may be changed in a range without contradicting or creating discord with the processing contents thereof.

### First Embodiment

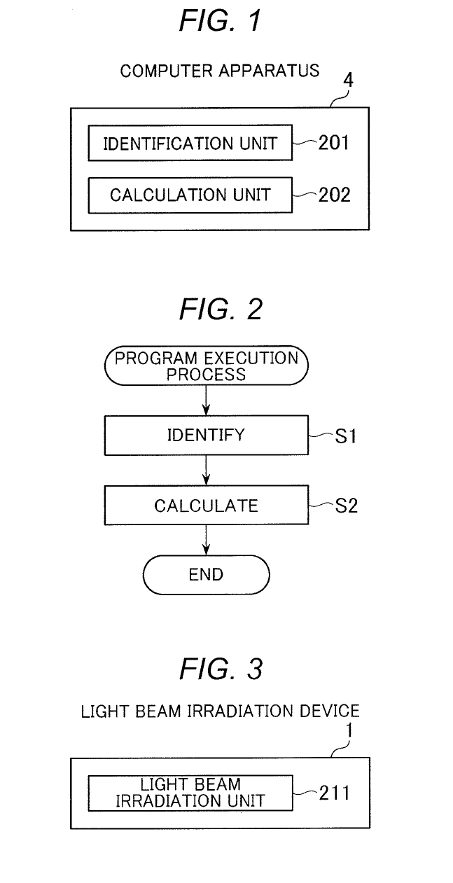

Next, an outline of a first embodiment of the present invention will be described. FIG. 1 is a block diagram illustrating a configuration of a computer apparatus, which corresponds to at least one embodiment according to the present invention. A computer apparatus 4 includes at least an identification unit 201 and a calculation unit 202.

The identification unit 201 has a function of identifying a light beam irradiation device corresponding to a light beam photographed by a photographing device. The calculation unit 202 has a function of calculating a position where the light beam irradiation device irradiates an irradiation target surface, as input data.

A program execution process in the first embodiment of the present invention will be described. FIG. 2 is a flowchart of a program execution process, which corresponds to at least one embodiment according to the present invention.

The computer apparatus 4 identifies a light beam irradiation device corresponding to a light beam photographed by a photographing device 3 (step S1). Next, calculation is performed by using a position where the light beam irradiation device identified in step S1 irradiates an irradiation target surface, as input data (step S2), and the process is terminated.

As an aspect of the first embodiment, it is possible to perceive a light beam irradiation device without depending on an irradiation angle of a light beam.

As an aspect of the first embodiment, it is possible to normally recognize a light beam and to perceive a light beam irradiation device even when a portion of the light beam is shielded by an obstacle.

In the first embodiment, the “light beam irradiation device” refers to, for example, a device that irradiates with a light beam, and includes a portable device and a device which is used in an installed state. The “irradiation target surface” refers to, for example, a screen for projector, and refers to a surface to which a video and the like can be projected. The “periodic pattern” refers to, for example, a pattern in which irradiated light beams are periodically blinked.

The “photographing device” refers to, for example, a device, such as a video camera and an infrared sensor camera, which is capable of performing photographing. The “computer apparatus” refers to, for example, an apparatus capable of performing processing on photographing data obtained by the photographing of the photographing device, and refers to a device capable of being connected to another device by communication.

### Second Embodiment

Next, an outline of a second embodiment of the present invention will be described. As a configuration of a computer apparatus in the second embodiment, the same configuration as that illustrated in the block diagram of FIG. 1 can be adopted. Further, as a flow of a program execution process in the second embodiment, the same configuration as that illustrated in the flowchart of FIG. 2 can be adopted.

In the second embodiment, the calculation unit 202 measures an irradiation time for which substantially the same position is irradiated with light beams on an irradiation target surface, and outputs a different calculation result depending on the measured irradiation time.

As an aspect of the second embodiment, it is possible to make a game more complicated and interesting by outputting a different calculation result depending on the length of an irradiation time for which substantially the same position is irradiated.

In the second embodiment, the “substantially the same position” refers to, for example, a position in a predetermined range based on certain specific positional coordinates. The “irradiation time measurer” refers to, for example, a unit that measures a time for which a light beam irradiation device irradiates an irradiation target surface with a light beam. The “different production result” refers to, for example, a case where a comment sentence is displayed in a case where substantially the same position is irradiated for a certain predetermined time, and a production result is different, like a change in the color of a background image, in a case where substantially the same position is irradiated for a different predetermined time.

### Third Embodiment

Next, an outline of a third embodiment of the present invention will be described. FIG. 3 is a block diagram illustrating a configuration of a light beam irradiation device, which corresponds to at least one embodiment according to the present invention. A light beam irradiation device 1 includes at least a light beam irradiation unit 211.

The light beam irradiation unit 211 has a function of irradiating with a light beam from the light beam irradiation device 1.

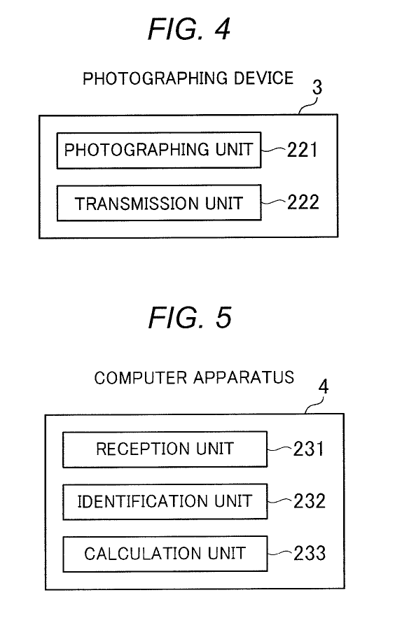

FIG. 4 is a block diagram illustrating a configuration of a photographing device, which corresponds to at least one embodiment according to the present invention. The photographing device 3 includes at least a photographing unit 221 and a transmission unit 222.

The photographing unit 221 performs photographing by using the photographing device 3. The transmission unit 222 transmits photographing data obtained by the photographing of the photographing unit 221 to a computer apparatus.

FIG. 5 is a block diagram illustrating a configuration of a computer apparatus, which corresponds to at least one embodiment according to the present invention. The computer apparatus 4 includes at least a reception unit 231, an identification unit 232, and a calculation unit 233.

The reception unit 231 receives photographing data transmitted from the transmission unit 222 of the photographing device 3. The identification unit 232 identifies a light beam irradiation device corresponding to a periodic pattern of a photographed light beam, on the basis of the photographing data received by the reception unit 231. The calculation unit 233 performs calculation by using a position on an irradiation target surface for the identified light beam irradiation device, as input data.

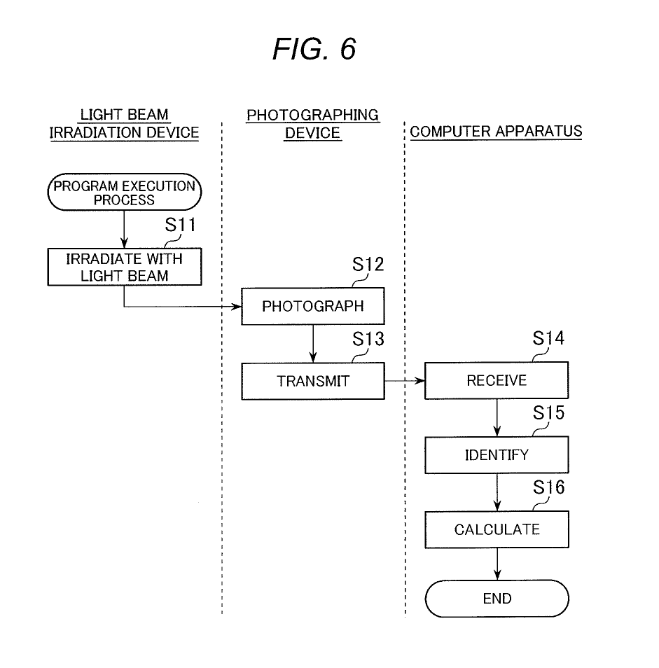

A program execution process in the third embodiment of the present invention will be described. FIG. 6 is a flowchart of a program execution process, which corresponds to at least one embodiment according to the present invention.

First, a user irradiates an irradiation target surface with a light beam having a different periodic pattern for each light beam irradiation device (step S11). The light beam irradiated to the irradiation target surface is photographed by the photographing device 3, and is temporarily held as photographing data (step S12). The photographing data obtained by the photographing is transmitted to the computer apparatus 4 (step S13). The computer apparatus 4 receives the photographing data transmitted in step S13 (step S14). The computer apparatus 4 identifies a light beam irradiation device corresponding to a periodic pattern of a photographed light beam, on the basis of the received photographing data (step S15). Finally, calculation is performed on the identified light beam irradiation device by using a position on an irradiation target surface as input data (step S16), and the process is terminated.

As an aspect of the third embodiment, it is possible to perceive a light beam irradiation device without depending on an irradiation angle of a light beam.

As an aspect of the third embodiment, it is possible to normally recognize a light beam and to perceive a light beam irradiation device even when a portion of the light beam is shielded by an obstacle.

In the third embodiment, the “periodic pattern” refers to, for example, a pattern in which an irradiated light beam is periodically blinked. The “irradiation target surface” refers to, for example, a screen for projector, and refers to a surface to which a video and the like can be projected. The “light beam irradiation device” refers to, for example, a device that irradiates with a light beam, and includes a portable device and a device which is used in an installed state.

In the third embodiment, the “photographing device” refers to, for example, a device, such as a video camera and an infrared sensor camera, which is capable of performing photographing. The “computer apparatus” refers to, for example, an apparatus capable of performing processing on an image obtained by the photographing of the photographing device, and refers to a device capable of being connected to another device by communication. The “photographing data” refers to data obtained by photographing.

### Fourth Embodiment

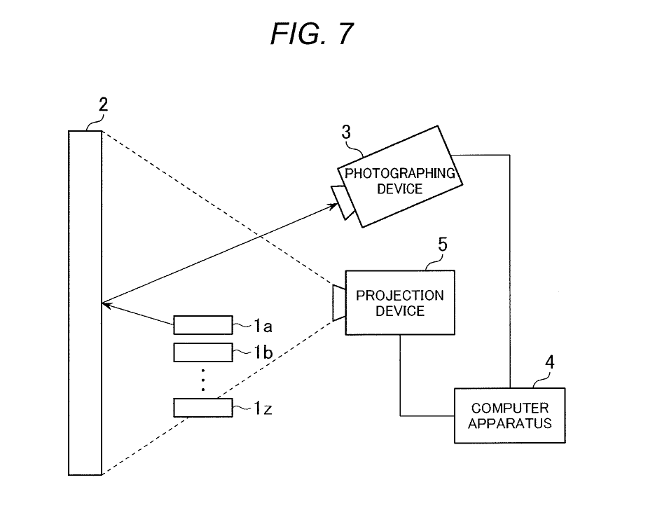

Next, an outline of a fourth embodiment of the present invention will be described. FIG. 7 is a block diagram illustrating a configuration of a system, which corresponds to at least one embodiment according to the present invention. As illustrated in the drawing, the system includes a plurality of light beam irradiation devices 1 (light beam irradiation devices 1a, 1b, . . . , and 1z), an irradiation target surface 2 which is irradiated with a light beam, the photographing device 3 that photographs a light beam which is irradiated to the irradiation target surface 2 from the light beam irradiation device 1 and is reflected, the computer apparatus 4 that performs processing on the basis of information on an image obtained by photographing, and a projection device 5 that projects the image processed by the computer apparatus 4 onto the irradiation target surface 2.

The light beam irradiation device 1 may be independently used without being connected to another device and the like, but may be capable of communicating with the computer apparatus 4 and transmitting an input signal to the computer apparatus 4 by using a mechanism, included in the light beam irradiation device, which inputs a user's instruction. In addition, the light beam irradiation device 1 may be a device that irradiates with invisible light, may be a device capable of irradiating with visible light, and may be a device irradiating with both visible light and invisible light.

It is preferable that the irradiation target surface 2 is formed of a material capable of reflecting a light beam irradiated from the light beam irradiation device 1. The photographing device 3 is connected to the computer apparatus 4 through a wired or wireless communication line. The computer apparatus 4 is connected to the photographing device 3 and the projection device 5 through a wired or wireless communication line. The projection device 5 is connected to the computer apparatus 4 through a communication line. The photographing device 3, the computer apparatus 4, and the projection device 5 may be equipment that are independent of each other, or may be a combined single equipment.

As an example of this embodiment, the light beam irradiation device 1 can be configured as a device capable of irradiating with two types of beams of a visible light beam and an invisible light beam (for example, an infrared light beam or the like). A player can easily ascertain an irradiation position by irradiating with a visible light beam, and can perceive a light beam irradiation device without being influenced by a projected video by irradiating with an invisible light beam.

As an example of this embodiment, it is possible to use an infrared light beam as an invisible light beam of the light beam irradiation device 1 and to use an infrared sensor camera for the photographing device 3. Here, it is possible to install a filter in a camera so that infrared rays emitted from the player do not interrupt operation. This is to cut a wavelength of approximately 9 μm to 10 μm which is equivalent to infrared rays emitted from a human body. It is preferable that the wavelength of infrared rays emitted by the light beam irradiation device 1 is set not to fall within the above-described range of the cut wavelength.

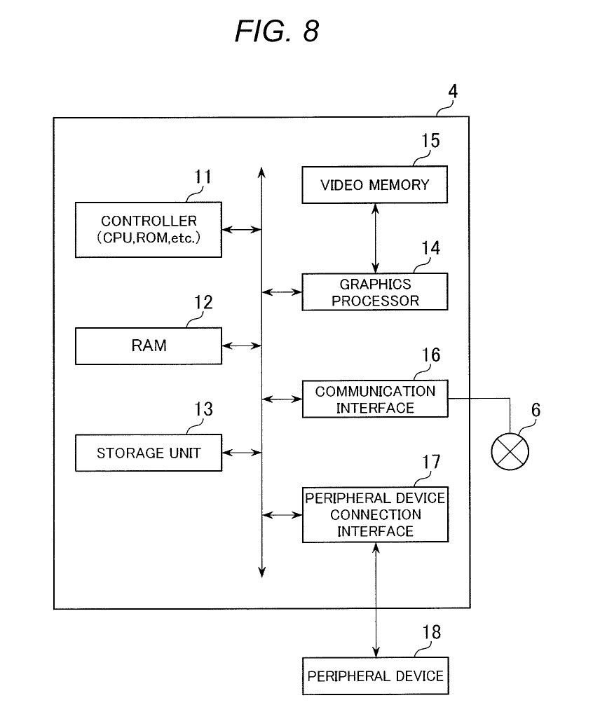

FIG. 8 is a block diagram illustrating a configuration of a computer apparatus, which corresponds to at least one embodiment according to the present invention. The computer apparatus 4 includes at least a controller 11, a Random Access Memory (RAM) 12, a storage unit 13, a graphics processor 14, a video memory 15, a communication interface 16, a peripheral device connection interface 17 and a peripheral device 18. All of these are connected to each other by an internal bus.

The controller 11 is constituted by a Central Processing Unit (CPU) and a Read Only Memory (ROM). The controller 11 executes a program stored in the storage unit 13, and controls the server apparatus 4. The RAM 12 is a work area of the controller 11. The storage unit 13 is a storage region for storing programs and data.

The controller 11 reads out the programs and the data from the RAM 12, and performs an execution process. The controller 11 outputs a drawing command to the graphics processor 14 by executing the processes of the program and data which are loaded to the RAM 12.

The graphics processor 14 draws one image in the unit of frames. For example, one frame time for the image is 1/30 seconds. The graphics processor 14 has a function of receiving a part of a calculation process relating to the drawing to disperse a load of the entire system.

The peripheral device 18 (such as a SD card and a camera for photographing) is connected to the peripheral device connection interface 17. The data which is read out from the peripheral device 18 is load in the RAM 12 and is subjected to calculation processing by the controller 11.

The communication interface 16 is capable of connection to the communication network 6 in a wireless or wired manner, and may receive the data via the communication network 6. The data received via the communication network 6 is load in the RAM 12 and is subjected to calculation processing by the controller 11, as the data which is read out from the peripheral device 18.

A program execution process in the fourth embodiment of the present invention will be described. An example of the fourth embodiment of the present invention is a game in which a virtual battle is performed with an enemy character by using a light beam irradiated from the light beam irradiation device, with respect to a video projected onto a wall surface.

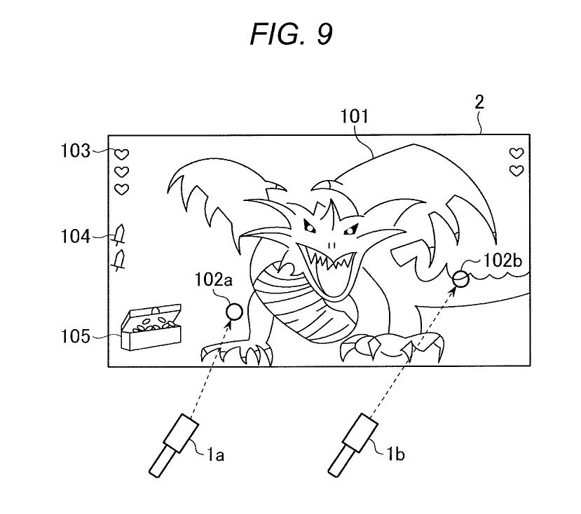

FIG. 9 is an example of a game execution screen, which corresponds to at least one embodiment according to the present invention. Although two light beam irradiation devices 1 are illustrated in the drawing, the number of light beam irradiation devices is not limited to two, and more light beam irradiation devices may be used.

In a video displayed on the irradiation target surface 2, at least an enemy character 101, a friend vitality 103, the number of times of usable lethal technique 104, and an acquirable item 105 are displayed. The friend vitality 103 represents a total value of physical strength of a player character, and a battle disable state is set when the display of the friend vitality 103 is eliminated, whereby a game is terminated. In addition, an enemy character is set to be in a battle disable state when the vitality (not shown in the drawing) of the enemy character 101 is eliminated, and it is determined that a player has won the game, whereby the game is terminated.

When the irradiation target surface 2 is irradiated with a visible light beam irradiated from the light beam irradiation device 1a, an irradiation point 102a is generated. Similarly, a visible light beam irradiated from the light beam irradiation device 1b generates an irradiation point 102b. It is assumed that substantially the same position is irradiated with a visible light beam and an invisible light beam which are irradiated from the light beam irradiation device 1.

Meanwhile, it is assumed that an invisible light beam irradiated from the light beam irradiation device 1a is repeatedly blinked with a pattern different from that of an invisible light beam of the light beam irradiation device 1b. A blinking pattern will be described later.

The photographing device 3 is disposed at a position where the light beams and the entire irradiation target surface 2 can be photographed. The irradiation target surface 2 may be the entirety of the ceiling, floor, front, back, right, and left surfaces, or may be any one of the surfaces. In addition, it is possible to use a plurality of photographing devices 3. As an example of this embodiment, the floor, front, back, right, and left surfaces, except for the ceiling, can be used as the irradiation target surface 2, and a method capable of photographing the entire irradiation target surface by hanging the photographing device 3 from the ceiling can be adopted for the photographing device 3.

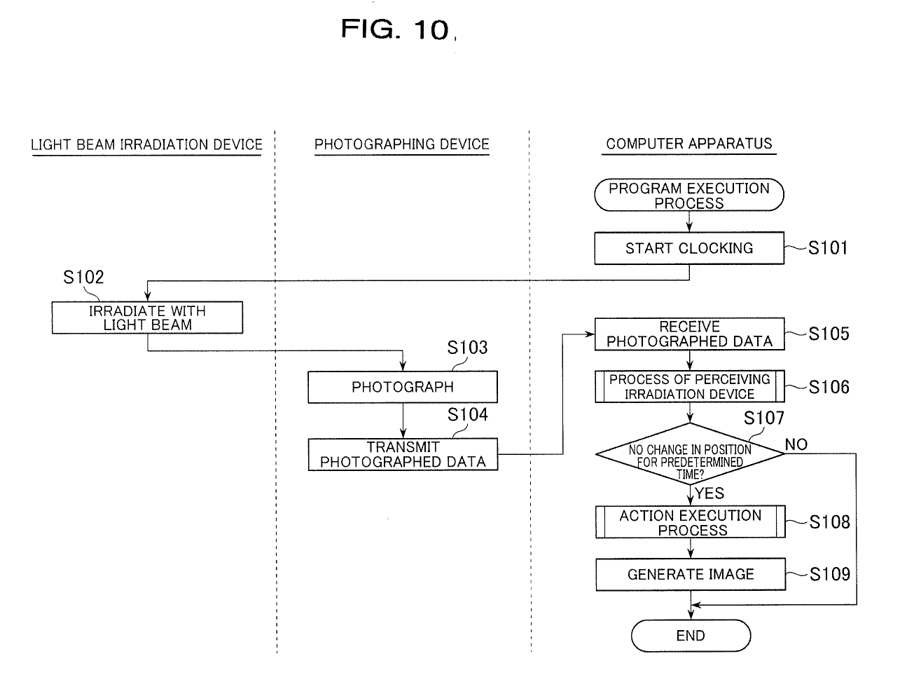

FIG. 10 is a flowchart of a program execution process, which corresponds to at least one embodiment according to the present invention. First, when a game is started, a control unit 11 of the computer apparatus 4 starts clocking (step S101). Next, a player irradiates the irradiation target surface 2 with a light beam by using the light beam irradiation device 1 (step S102).

Reflected light of the invisible light beam irradiated in step S102 is photographed by the photographing device 3 (step S103). An image obtained by the photographing is transmitted to the computer apparatus 4 through a communication line (step S104). Here, the communication line may be a wired or wireless line, and although the type of line does not matter, it is preferable to use equipment which does not cause a time lag and is capable of high-speed communication in order to rapidly perform processing in the computer apparatus 4.

The computer apparatus 4 receives the photographing data transmitted in step S104 (step S105). The light beam irradiation device 1 is perceived on the basis of the received photographing data (step S106).

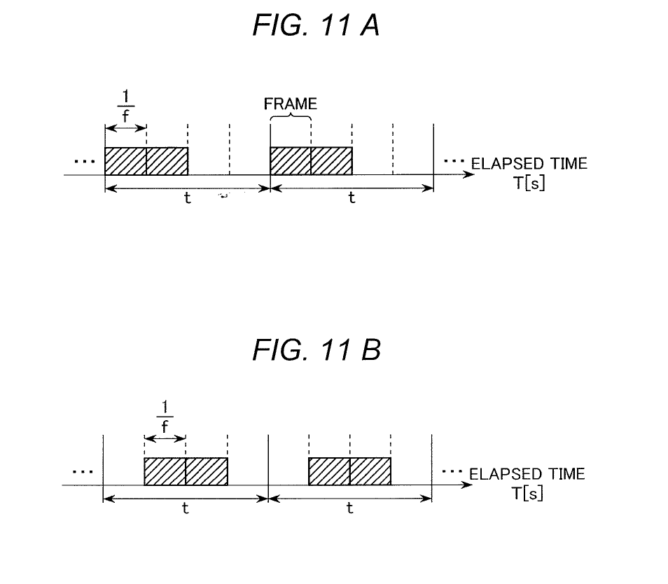

Here, a process of perceiving the light beam irradiation device 1 will be described. FIGS. 11A and 11B are diagrams related to an example of a blinking pattern, which corresponds to at least one embodiment according to the present invention. In the drawing, the horizontal axis represents an elapsed time T, and a bar is displayed in the vertical axis in a case where the reflection of a light beam is detected.

FIGS. 11A and 11B illustrate a blinking pattern which is repeated in cycles of t seconds. The cycle t of the blinking pattern includes four frames. The frame represents one frame at a frame rate f of the photographing device 3, and the number of seconds per frame is 1/f seconds.

It is preferable that the cycle t of the blinking pattern in the light beam irradiation device 1 is equal to or larger than 1/f which is the number of seconds of one frame of the photographing device 3. In particular, it is preferable that the cycle t is a multiple of the frame. This is to accurately determine the cycle of a light beam irradiated from the light beam irradiation device 1. The determination of the blinking pattern will be described later.

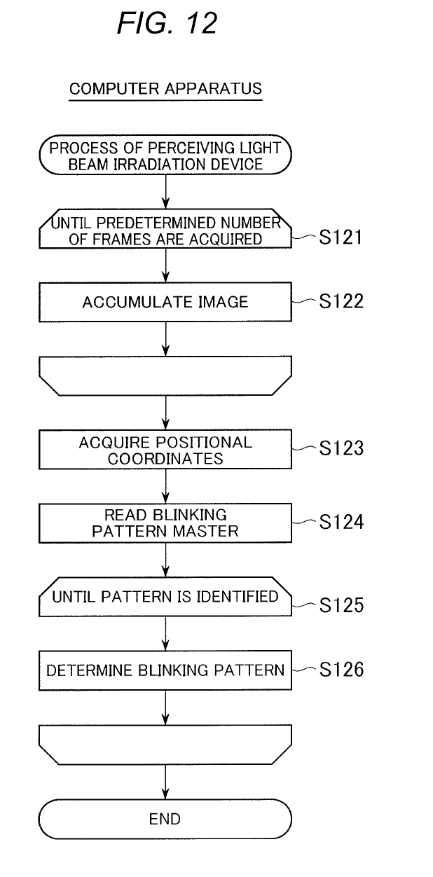

Next, a method of perceiving the light beam irradiation device 1 from an image captured by the photographing device 3 will be described. FIG. 12 is a flowchart of a process of perceiving a light beam irradiation device, which corresponds to at least one embodiment according to the present invention.

First, photographing data is received from the photographing device 3 until images having a predetermined number of frames are accumulated, in order to ascertain a blinking pattern of the light beam irradiation device (steps S121 and S122). When the photographing data is accumulated, positional coordinates of the irradiated light beam are acquired from the photographing data (step S123).

Various methods may be adopted as a method of acquiring positional coordinates, and an example of the method is a method of acquiring coordinates of a position irradiated with a light beam from a group of still images in units of frames. In the example of FIGS. 11A and 11B, one cycle of a blinking pattern includes four frames, and thus four images arranged in time series are compared with each other to acquire positional coordinates. Here, an irradiation position may be slightly changed due to camera shake or the like. In this case, for example, an average value of coordinates of four image irradiation positions is calculated, and the light beam irradiation device 1 may be perceived using patterns of the irradiation positions included in a fixed range from the average positional coordinates.

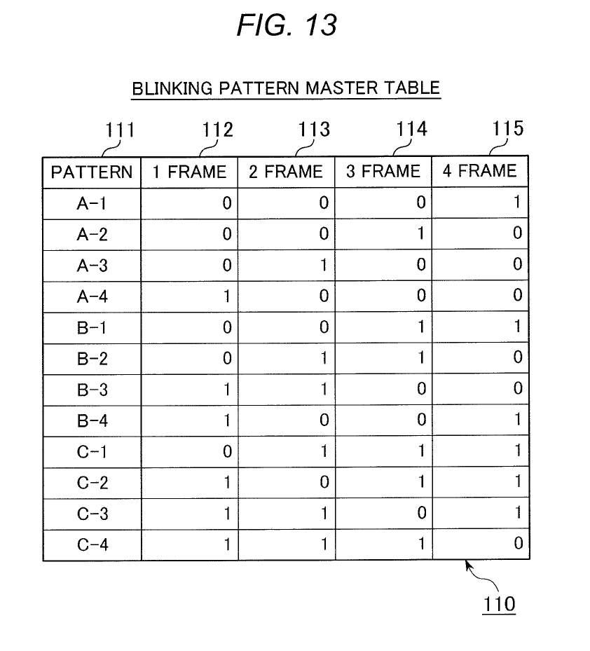

Subsequently, blinking pattern master data stored in a storage unit 13 of the computer apparatus 4 is read (step S124). FIG. 13 is a diagram illustrating a blinking pattern master table, which corresponds to at least one embodiment according to the present invention. A first frame 112, a second frame 113, a third frame 114, and a fourth frame 115 are stored in a blinking pattern master table 110 in association with a pattern 111. The pattern 111 is information for perceiving a blinking pattern.

The first frame 112, the second frame 113, the third frame 114, and the fourth frame 115 are frames for indicating whether or not a light beam is irradiated from each of the frames by respectively associating still images, obtained by arranging pieces of photographing data each obtained for each frame in time series, with the first frame, the second frame, the third frame, and the fourth frame. A case where a light beam is irradiated is indicated by 1, and a case where a light beam is not irradiated is indicated by 0. For example, in the pattern illustrated in FIG. 11A, a light beam is irradiated from a first frame and a second frame and is not irradiated from a third frame and a fourth frame, and thus the pattern 111 illustrated in FIG. 13 corresponds to a pattern of “B-3”. Similarly, in the pattern illustrated in FIG. 11B, the pattern 111 illustrated in FIG. 13 corresponds to a pattern of “B-2”.

By using the positional coordinates acquired in step S123, a blinking pattern in the positional coordinates is identified from four images, and is compared with the blinking pattern master data which is read in step S124 to determine whether or not the blinking pattern and the blinking pattern master data match each other (step S126). This determination is repeated until the blinking pattern is identified (step S125). In this manner, it is possible to perceive the light beam irradiation device 1 by the identification of the blinking pattern.

Subsequently, referring back to FIG. 10, after the perceiving of the light beam irradiation device 1 has been finished, the computer apparatus 4 determines whether or not a change has been made to the positional coordinates where a light beam is irradiated (step S107).

Here, the determination of whether or not a change is made to positional coordinates will be described. A case where a change is not made to positional coordinates means determination of whether being located at substantially the same position, and means that a distance between coordinates of a certain frame and the previous frame is calculated and it is determined whether or not the distance falls within a predetermined range. The determination may be sequentially performed between two frames, or may be performed whenever a predetermined number of frames are accumulated.

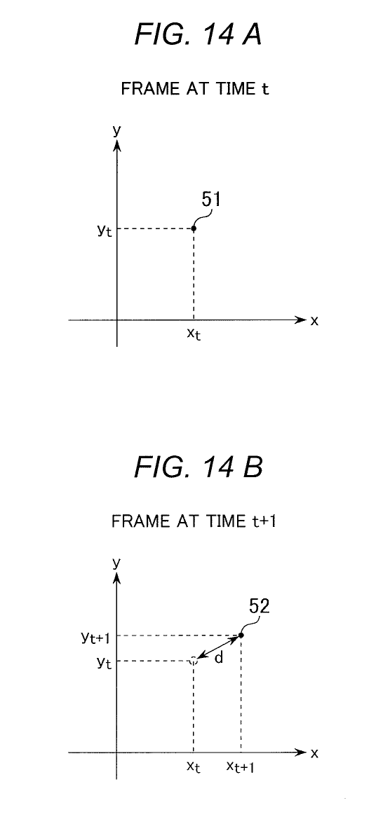

FIGS. 14A and 14B are diagrams illustrating a determination method related to a change in positional coordinates, which corresponds to at least one embodiment according to the present invention. FIG. 14A illustrates positional coordinates of a light beam at time t. Coordinates of a position 51 irradiated with the light beam at time t are (xₜ, yₜ). On the other hand, FIG. 14B illustrates positional coordinates of a light beam at time t+1 after one frame of time t. Coordinates of a position 52 irradiated with the light beam at time t+1 are (xₜ₊₁, yₜ₊₁), and a distance d between the coordinates of the position 51 and the coordinates of the position 52 can be represented by the following expression.

d=\sqrt{(xₜ₊₁−xₜ)²+(yₜ₊₁−yₜ)²} (1)

It is assumed that a change is made to the positional coordinates in a case where the distance d exceeds a predetermined length, and it is determined that the positional coordinates have not changed and substantially the same position is irradiated in a case where the distance d does not exceed the predetermined length.

When there is a change in the positional coordinates (NO in step S107), it can be assumed that a light beam moves. In addition, when there is no change in the positional coordinates (YES in step S107), it is assumed that a player intentionally indicates the position, and in a case where a change is not made to the positional coordinates for a predetermined time, an action execution process for a player character is performed on an irradiation position by the computer apparatus 4 (step S108).

An action in the action execution process may be changed depending on by which light beam of the light beam irradiation devices the action is caused. For example, shooting using a gun is performed on an irradiation position in a case of a certain light beam irradiation device, and shooting using a machine gun is performed on an irradiation position in a case of another device.

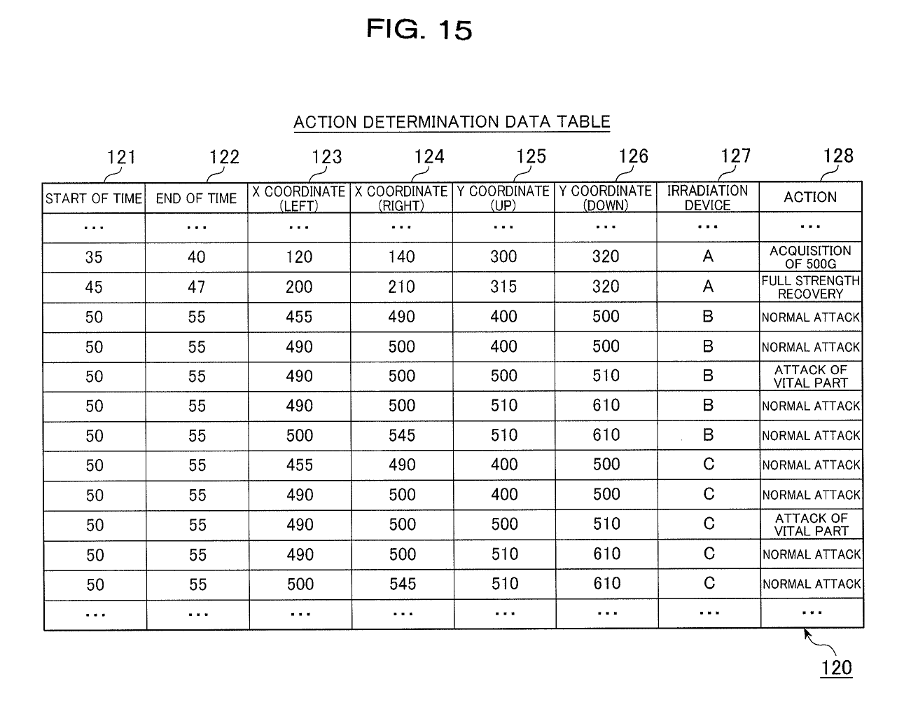

Next, the action execution process in step S108 will be described. FIG. 15 is a diagram illustrating an action determination data table, which corresponds to at least one embodiment according to the present invention. In an action determination data table 120, an action 128 is stored in association with start of time 121, end of time 122, an x coordinate (left) 123, an x coordinate (right) 124, a y coordinate (up) 125, a y coordinate (down) 126, and an irradiation device 127.

Values shown in the start of time 121 and the end of time 122 indicate a period of time for determining an action. It is determined whether or not an elapsed time of the clocking started in step S101 is between the value shown in the start of time 121 and the value shown in the end of time 122.

The x coordinate (left) 123, the x coordinate (right) 124, the y coordinate (up) 125, and the y coordinate (down) 126 indicate positional coordinates of an irradiated light beam by which an action can be determined. It is determined whether or not the positional coordinates of the irradiated light beam are included in a quadrangle having four points, which are indicated by the x coordinate (left) 123, the x coordinate (right) 124, the y coordinate (up) 125, and the y coordinate (down) 126, as the vertexes.

The irradiation device 127 represents by which irradiation device a light beam is irradiated. In this manner, for example, in a case where a player of an irradiation device B defeats a certain enemy character, only the irradiation device B can acquire an item, whereby distinguishment can be performed.

As described above, in a case where time when irradiation is performed, positional coordinates where irradiation is performed, and an irradiation device used for irradiation match conditions, the action 128 is determined from the action determination data table 120. For example, in a case where an elapsed time is “38” seconds, an x coordinate is “130”, a y coordinate is “315”, and an irradiation device is “A”, the action 128 is “acquisition of 500G”, and a player handling an irradiation device A can acquire 500G which is virtual currency.

Examples of the action include picking-up of an item and the like in a case where a treasure chest, an item, or the like is displayed in positional coordinates where irradiation is performed, attack on an enemy character in a case where the enemy character is displayed in the positional coordinates, and the use of a lethal technique specific to a player character in a case where an icon of the lethal technique is displayed in the positional coordinates. In addition, it is also possible to define an action which is usable at all times by registering data without limitations of the start of time 121 and the end of time 122. For example, the display of a screen is changed so as to enlarge or reduce an image displayed on the irradiation target surface 2 when a position in a predetermined range is irradiated with a light beam.

When the calculation of the action execution process is performed in step S108, the computer apparatus 4 generates an image based on calculation results (step S109). The generated image is irradiated toward the irradiation target surface 2 from the projection device 5, and the player can know operation results instructed by the player.

Further, a design may be made such that an input unit such as a button is provided in the light beam irradiation device 1, and an input signal is transmitted to the computer apparatus 4. In this case, the calculation of an action execution process is performed on the basis of input information from the light beam irradiation device 1, and an image is generated in step S109, in addition to the action execution process in step S108.

In addition, the light beam irradiation device 1 may include a vibration mechanism that vibrates when a signal is received. In the computer apparatus 4, a vibration signal is transmitted to the light beam irradiation device 1 when the action execution process is performed in step S108, and the vibration mechanism vibrates when the light beam irradiation device 1 receives the vibration signal. For example, the vibration mechanism may vibrate when an attack is received from an enemy character.

A game to which the fourth embodiment is applicable is, for example, a game performed by a plurality of players in cooperation with each other or a game for one person, and may be a game performed by setting a light beam irradiation device in the left hand to be a shield and setting a light beam irradiation device in the right hand to be a sword. In addition, the game may be a game in which a device to be used among a plurality of light beam irradiation devices is exchanged every time.

In the fourth embodiment, an image is projected onto the irradiation target surface 2 by using the projection device 5, but a configuration in which the projection device 5 is not used may be adopted. For example, a huge display may be connected to the computer apparatus 4 to output an image having been subjected to calculation processing.

In the fourth embodiment, both visible light and invisible light may be irradiated from the light beam irradiation device 1, but the light beam irradiation device may irradiate only invisible light. In this case, for example, an irradiation position of invisible light is recognized by the computer apparatus 4 on the basis of photographing data of a camera that photographs the invisible light. When an image projected by the projection device 5 is generated, projection may be performed by synthesis of an aimed image.

In the fourth embodiment, as a method of perceiving the light beam irradiation device 1, a method of perceiving the light beam irradiation device 1 on the basis of a blinking pattern of a light beam irradiated from the light beam irradiation device 1 has been described, but the present invention is not limited thereto, and for example, light beams irradiated from the light beam irradiation device 1 may be made to have different colors. In this case, color obtained by the irradiation of each of the light beam irradiation device 1 is perceived by using, for example, photographing data of a camera performing photographing, so that the computer apparatus 4 may recognize a position of irradiation performed by each light beam irradiation device 1. Further, the color of a light beam irradiated from the light beam irradiation device 1 and the color used for an image projected by the projection device 5 may be distinguished from each other in advance, so that an irradiation position is easily perceived even in the middle of the projection of the image. In a case where the color of the light beam irradiated from the light beam irradiation device 1 and the color used for the image projected by the projection device 5 overlap each other, it is possible to perceive whether or not the colors overlap each other by detecting a difference in the amount of light irradiated.

In the fourth embodiment, as a method of perceiving the light beam irradiation device 1, a method of perceiving the light beam irradiation device 1 on the basis of a blinking pattern of a light beam irradiated from the light beam irradiation device 1 has been described, but the present invention is not limited thereto, and for example, a design may be made such that the amounts of light beams irradiated from the light beam irradiation devices 1 are different from each other. In this case, the amount of light beam irradiated from each of the light beam irradiation devices 1 is measured by using, for example, photographing data of a camera performing photographing, so that the computer apparatus 4 may recognize a position of irradiation performed by each light beam irradiation device 1 by measuring. Further, it is possible to increase the accuracy of perception by combining sensors capable of measuring the amount of light, in addition to using a camera for photographing regarding the photographing device 3.

In the fourth embodiment, as a method of perceiving the light beam irradiation device 1, a method of perceiving the light beam irradiation device 1 on the basis of a blinking pattern of a light beam irradiated from the light beam irradiation device 1 has been described, but the present invention is not limited thereto. For example, the color of a light beam or the amount of light beam may be changed in accordance with a predetermined pattern, instead of a blinking pattern of a light beam irradiated from the light beam irradiation device 1. In this case, a pattern related to a change in the color of a light beam irradiated from the light beam irradiation device 1 and a pattern related to a change in the amount of light may be perceived by using, for example, photographing data of a camera performing photographing, so that the computer apparatus 4 may recognize a position of irradiation performed by each light beam irradiation device 1. Further, it is possible to increase the accuracy of perception by combining sensors capable of measuring the amount of light, in addition to using a camera for photographing regarding the photographing device 3.

As an aspect of the fourth embodiment, it is possible to perceive a light beam irradiation device without depending on an irradiation angle of a light beam and to provide a highly-interesting game using a plurality of light beam irradiation devices.

As an aspect of the fourth embodiment, it is possible to normally recognize a light beam and to perceive a light beam irradiation device even when a portion of the light beam is shielded by an obstacle.

As an aspect of the fourth embodiment, a light beam irradiation device includes a vibration mechanism, and thus it is possible to provide a scene with a feeling of presence in the progress of a game, such as a feeling of vibration in a case where an attack is made on an enemy or an attack is made by an enemy.

As an aspect of the fourth embodiment, a light beam irradiated from a light beam irradiation device is infrared rays, and thus there is an advantage in that the light beam is hardly harmful to a human body. Although invisible light also includes ultraviolet rays, but the ultraviolet rays are harmful to a human body due to basking in a large amount, and thus it is preferable to use the invisible light with performing appropriate processing.

In the fourth embodiment, the “light beam irradiation device” refers to, for example, a device that irradiates a light beam, and includes a portable device and a device which is used in an installed state. The “irradiation target surface” refers to, for example, a screen for projector, and refers to a surface to which a video and the like can be projected. The “periodic pattern” refers to, for example, a pattern in which irradiated light beams are periodically blinked.

The “photographing device” refers to, for example, a device, such as a video camera and an infrared sensor camera, which is capable of performing photographing. The “computer apparatus” refers to, for example, an apparatus capable of performing processing on photographing data obtained by the photographing of the photographing device, and refers to a device capable of being connected to another device by communication.

The “operation instruction information” refers to, for example, instruction information on a player's operation, and includes information on the strength of force for gripping an object, information on a trigger for operating a gun, and the like. The “predetermined signal” refers to, for example, a signal received by a vibration mechanism that generates vibration, and includes a start-up signal for starting up the vibration mechanism when the signal is received. The “game program” refers to, for example, a program for executing a game, and refers to a program executed by a computer apparatus.

### Fifth Embodiment

Next, an outline of a fifth embodiment of the present invention will be described. An example of the fifth embodiment of the present invention is a learning system in a training institute. Although not shown in the drawing, the learning system uses, for example, a light beam irradiation device mountable on a head, and a portable light beam irradiation device that indicates danger predicted by a user. The light beam irradiation device on the head and the portable light beam irradiation device are configured to have different periodic patterns of a light beam.

The learning system according to the fifth embodiment is used by a user seating on a simulation device modeled on, for example, a car, and has a windshield and window glasses on the light and left sides of a driver's seat, as irradiation target surfaces. An image projected onto the irradiation target surface of the windshield is a scene viewed from a user driving the car, and a photographing device photographing the windshield and the right and left window glasses is set in the simulation device.

The user can confirm whether or not to properly practice points to note in the driving of the car by using the simulation device. Here, the user may have allotted points of, for example, 100 points, a method of determining success or failure by deduction of points may be used, or a method of adding points from zero may be used. Hereinafter, a case where deduction of points is adopted will be described.

Next, a program execution process in the fifth embodiment of the present invention will be described. The program execution process will be described using the flowchart of FIG. 10.

First, a program is started from the starting of a car and clocking starts (step S101). A user fastens a seat belt and adjusts positions of a rearview mirror and side-view mirrors. Here, a light beam is irradiated from a light beam irradiation device worn on the user's head (step S102), and a photographing device photographs the light beam (step S103). Photographing data obtained by the photographing of the photographing device is transmitted (step S104), and a computer apparatus receives the photographing data (step S105).

The computer apparatus perceives the position of the irradiation and the light beam irradiation device (step S106). In a case where a change is not made to the position for a predetermined time (YES in step S107), it is determined that an action of adjusting the positions of the mirrors has been executed (step S108) to generate an image in which the wording of “mirror position has been adjusted” is displayed on a screen (step S109). In a case where the adjustment of the mirrors is neglected and the car is started in this state, points are deducted from the user's allotted points.

In the program of the fifth embodiment, while the user is driving, a task may be displayed. For example, the task is like “pass a truck”, “go straight in front of a kindergarten”, or the like. In this case, the user predicts danger such as a possibility that a person jumps out from behind a truck, and needs to pay attention to the front of the truck.

Consequently, in order to indicate the paying of attention, it is possible to prevent the deduction of points by performing irradiation on the front of the truck by using a portable light beam irradiation device. In order to make the user know the prevention of the deduction of points, a mark o and a comment related to the prediction of danger may be displayed. The processing of the program is the same as the processing from step S101 to step S109 in the above-described flowchart of FIG. 10.

In this manner, the program is not limited to a program related to a game, and it is also possible to apply a configuration in which a position is indicated using a light beam with respect to an image.

As an aspect of the fifth embodiment, it is possible to perceive a light beam irradiation device without depending on an irradiation angle of a light beam and to provide a learning system using a plurality of light beam irradiation devices. In particular, there is an advantage in that it is possible to prevent an error occurring from a difference in an irradiation angle due to a difference in body height or a difference in seated height between persons and to accurately perform perception.

As an aspect of the fifth embodiment, it is possible to normally recognize a light beam and to perceive a light beam irradiation device even when a portion of the light beam is shielded by an obstacle.

In the fifth embodiment, the “light beam irradiation device” refers to, for example, a device that irradiates with a light beam, and includes a portable device and a device which is used in an installed state. The “irradiation target surface” refers to, for example, a screen for projector, and refers to a surface to which a video and the like can be projected. The “periodic pattern” refers to, for example, a pattern in which irradiated light beams are periodically blinked.

The “photographing device” refers to, for example, a device, such as a video camera and an infrared sensor camera, which is capable of performing photographing. The “computer apparatus” refers to, for example, an apparatus capable of performing processing on photographing data obtained by the photographing of the photographing device, and refers to a device capable of being connected to another device by communication.

### APPENDIX

The above-described embodiments are described so that those skilled in the art can implement the following inventions.

[1] A program executed in a computer apparatus which is capable of communicating with or being connected to a photographing device that photographs different light beams irradiated to an irradiation target surface from a plurality of light beam irradiation devices, the program causing the computer apparatus to function as:
an identificator that identifies the light beam irradiation devices corresponding to the light beams photographed by the photographing device; and
a calculator that performs calculation of a predetermined program by using a position on the irradiation target surface for the light beam irradiation device identified by the identificator, as input data.

[2] The program according to [1],
wherein the different light beams are light beams having different periodic patterns, and
wherein the identificator identifies the light beam irradiation device corresponding to the periodic pattern of the photographed light beam.

[3] The program according to [1] or [2],
wherein the calculator includes an irradiation time measurer that measures an irradiation time for which substantially the same position on the irradiation target surface is irradiated with light beams, and outputs different calculation results in accordance with the irradiation time measured by the irradiation time measurer.

[4] The program according to any one of [1] to [3], causing the computer apparatus to function as:
an operation receiver that receives operation instruction information transmitted from the light beam irradiation device,
wherein the calculator performs calculation in accordance with an operation instruction received by the operation receiver.

[5] The program according to any one of [1] to [4], causing the computer apparatus to further function as:

an image generator that generates an image according to the calculation results obtained by the calculation of the calculator.

[6] The program according to [5],
wherein the image generated by the image generator is displayed on the irradiation target surface.

[7] The program according to any one of [1] to [6],
wherein the light beam irradiation device is capable of communicating with or being connected to the computer apparatus, and has a function of vibrating when a predetermined signal is received, and
wherein the program causing the computer apparatus to further function as:
a signal transmitter that transmits a predetermined signal for causing the light beam irradiation device to generate vibration, according to the calculation results obtained by the calculation of the calculator.

[8] The program according to any one of [1] to [7],
wherein the light beams are infrared rays.

[9] The program according to any one of [1] to [8],
wherein the predetermined program is a game program.

[10] A computer apparatus which is capable of communicating with or being connected to a photographing device that photographs different light beams irradiated to an irradiation target surface from a plurality of light beam irradiation devices, the computer apparatus including:

an identificator that identifies the light beam irradiation devices corresponding to the light beams photographed by the photographing device; and
a calculator that performs calculation of a predetermined program by using a position on the irradiation target surface for the light beam irradiation device identified by the identificator, as input data.

[11] A program execution method executed in a computer apparatus which is capable of communicating with or being connected to a photographing device that photographs different light beams irradiated to an irradiation target surface from a plurality of light beam irradiation devices, the program execution method including:
a step of identifying the light beam irradiation devices corresponding to the light beams photographed by the photographing device; and
a step of performing calculation of a predetermined program by using a position on the irradiation target surface for the identified light beam irradiation device, as input data.

[12] A computer system including:
a plurality of light beam irradiation devices that irradiate an irradiation target surface with a light beam having a predetermined periodic pattern;
a photographing device that photographs the light beam with which the irradiation target surface is irradiated; and
a computer apparatus that is capable of communicating with or being connected to the photographing device,
wherein the light beam irradiation device includes a light beam irradiator that irradiates an irradiation target surface with different light beams,
wherein the photographing device includes
a photographer that photographs the light beam with which the irradiation target surface is irradiated, and
a transmitter that transmits photographing data obtained by the photographing of the photographer to the computer apparatus, and
wherein the computer apparatus includes
a receptor that receives the photographing data from the photographing device,
an identificator that identifies the light beam irradiation device corresponding to the photographed light beam, on the basis of the received photographing data, and
a calculator that performs calculation of a predetermined program by using a position on the irradiation target surface for the light beam irradiation device identified by the identificator, as input data.

1. A non-transitory computer-readable recording medium including a program executed in a computer apparatus which is capable of communicating with or being connected to a photographing device that photographs different light beams irradiated to an irradiation target surface from a plurality of light beam irradiation devices, the program causing the computer apparatus to function as:
an identificator that identifies the light beam irradiation devices corresponding to the light beams photographed by the photographing device; and
a calculator that performs calculation of a predetermined program by using a position on the irradiation target surface for the light beam irradiation device identified by the identificator, as input data.

2. The non-transitory computer-readable recording medium according to claim 1,
wherein the different light beams are light beams having different periodic patterns, and
wherein the identificator identifies the light beam irradiation device corresponding to the periodic pattern of the photographed light beam.

3. The non-transitory computer-readable recording medium according to claim 1,
wherein the calculator includes an irradiation time measurer that measures an irradiation time for which substantially the same position on the irradiation target surface is irradiated with light beams, and outputs different calculation results in accordance with the irradiation time measured by the irradiation time measurer.

4. The non-transitory computer-readable recording medium according to claim 1, causing the computer apparatus to function as:
an operation receiver that receives operation instruction information transmitted from the light beam irradiation device,
wherein the calculator performs calculation in accordance with an operation instruction received by the operation receiver.

5. The non-transitory computer-readable recording medium according to claim 1, causing the computer apparatus to further function as:
an image generator that generates an image according to the calculation results obtained by the calculation of the calculator.

6. The non-transitory computer-readable recording medium according to claim 5,
wherein the image generated by the image generator is displayed on the irradiation target surface.

7. The non-transitory computer-readable recording medium according to claim 1,
wherein the light beam irradiation device is capable of communicating with or being connected to the computer apparatus, and has a function of vibrating when a predetermined signal is received, and
wherein the program causing the computer apparatus to further function as:
a signal transmitter that transmits a predetermined signal for causing the light beam irradiation device to generate vibration, according to the calculation results obtained by the calculation of the calculator.

8. A computer apparatus which is capable of communicating with or being connected to a photographing device that photographs different light beams irradiated to an irradiation target surface from a plurality of light beam irradiation devices, the computer apparatus including:
an identificator that identifies the light beam irradiation devices corresponding to the light beams photographed by the photographing device; and
a calculator that performs calculation of a predetermined program by using a position on the irradiation target surface for the light beam irradiation device identified by the identificator, as input data.

9. A program execution method executed in a computer apparatus which is capable of communicating with or being connected to a photographing device that photographs different light beams irradiated to an irradiation target surface from a plurality of light beam irradiation devices, the program execution method including:
a step of identifying the light beam irradiation devices corresponding to the light beams photographed by the photographing device; and
a step of performing calculation of a predetermined program by using a position on the irradiation target surface for the identified light beam irradiation device, as input data.

10. (canceled)

11. The non-transitory computer-readable recording medium according to claim 1,
wherein the light beams are infrared rays.

12. The non-transitory computer-readable recording medium according to claim 1,
wherein the predetermined program is a game program.
